(19) United States
(12) Patent Application Publication
(10) Pub. No.: US 2023/0419428 A1
(43) Pub. Date: Dec. 28, 2023

(54) USING LOCATION BASED TRIGGERING TO GENERATE INFORMATION FOR HOMEBUYERS

(71) Applicant: STATE FARM MUTUAL AUTOMOBILE INSURANCE COMPANY, Bloomington, IL (US)

(72) Inventors: Joseph P. Harr, Bloomington, IL (US); Andrea Lee Rhoades, Kenney, IL (US); Katherine Blaine Carragher, Willow Springs, IL (US); Shawn M. Call, Bloomington, IL (US); Bryan R. Nussbaum, Bloomington, IL (US)

(21) Appl. No.: 16/909,448

(22) Filed: Jun. 23, 2020

Related U.S. Application Data
(63) Continuation of application No. 14/820,779, filed on Aug. 7, 2015, now abandoned.
(60) Provisional application No. 62/117,300, filed on Feb. 17, 2015.

(51) Int. Cl. G06Q 50/16; G06Q 40/08; G06Q 30/02

(52) U.S. Cl. CPC G06Q 50/16; G06Q 40/08; G06Q 30/0267

(57) ABSTRACT

Techniques are disclosed to display a dwelling's selling features on a mobile computing device as a user walks through a home. One or more transmitters may be positioned throughout a dwelling. When the mobile computing device is within a threshold range of a transmitter, the mobile computing device may send data identifying the transmitter to back end components. The back end components may correlate the identifying data with selling features associated with that dwelling location. The mobile computing device may receive this information from the one or more back end components and display the selling features. Other methods are also provided to trigger information to be displayed implementing geofences and near field communications (NFC). User feedback may be solicited and stored as part of a user profile, which may be used for marketing, advertising, to calculate homeowners insurance premium or home loan quotes, handle insurance claims, or other suitable purposes.

### CROSS REFERENCE TO RELATED APPLICATIONS

This application is a continuation application that claims priority to and the benefit of the filing date of U.S. application Ser. No. 14/820,779, filed on Aug. 7, 2015 and entitled “USING LOCATION BASED TRIGGERING TO GENERATE INFORMATION FOR HOMEBUYERS,” which claims the benefit of U.S. Provisional Patent Application No. 62/117,300, filed on Feb. 17, 2015, and entitled “Using Location Based Triggering to Generate Information for Homebuyers.” The disclosures of the above-referenced applications are hereby expressly incorporated by reference in their entirety.

### FIELD OF THE DISCLOSURE

The present disclosure relates generally to generating information for potential (or existing) homebuyers and, more particularly, to displaying information on a mobile computing device related to home features while potential homebuyers tour a home and/or using the home feature information for insurance-related purposes, such as generating quotes and/or handling claims.

### BACKGROUND

In many cases, a potential homebuyer may tour and evaluate a home prior to making an offer. Because buying a home is a large financial decision for most people, potential homebuyers may want to obtain detailed information on the home to be purchased. For example, interested homebuyers may inquire about the age of the home, details regarding recent renovations, the types of appliances, the age of furnaces and hot water heaters, a brand name associated with flooring products or window treatments, the type of wood used for cabinetry or flooring, etc.

As a result, a listing agent may provide pamphlets or other printouts that anticipate and attempt to answer these types of questions. However, such printouts incur costs for the seller, may not address a satisfactory amount of detail and, once printed, cannot easily be modified if the information later changes or is not accurate.

Mobile applications may be utilized by realtors to augment the home buying process but may have several drawbacks. For example, conventional mobile applications may not be interactive in nature and are generally limited to displaying the same information a homebuyer would find through an online listing of the property. Furthermore, conventional mobile applications may not elicit feedback from the user once the home has been viewed.

### BRIEF SUMMARY

One or more transmitters are installed at predetermined locations throughout a dwelling, which may be offered for sale or otherwise toured by interested parties. The predetermined locations may be strategically selected to coincide with locations of the dwelling that users may express the most interest, such as kitchens, bathrooms, bedrooms, living rooms, garages, patios, etc. An application may be installed on a user's mobile computing as the user tours the dwelling. When within a threshold distance of a transmitter, the application may cause the mobile computing device to detect identifying data broadcasted from the transmitter and communicate this identifying data with one or more back end components. Using the identifying data, the one or more backend components may determine the location of the mobile computing device within the dwelling and communicate an appropriate action to be performed on the mobile computing device, which may be a different action as the mobile computing device comes within range of each transmitter. This action may include, for example, displaying images, test, or a video of the relevant selling features of the dwelling corresponding to the transmitter location.

The mobile computing device may receive data indicative of the relevant selling features from the transmitters themselves and display this information with or without communicating with the backend components. Regardless of how the data indicative of the relevant selling features is received, these actions may be directed to identifying selling features of the dwelling associated with the user's present location in the dwelling associated with the transmitter location. The transmitters may be omitted and, via communication with one or more of the backend components, the location of the mobile computing device may detected via another means, such as geofencing, proximity to wireless access points associated with the dwelling, etc.

Furthermore, the communications between the mobile computing device and the backend components may be utilized to provide additional functionality for marketing and/or insurance purposes. The mobile computing device may display prompts, gather feedback from the user, determine whether a homeowners insurance quote is desired, store a log of homes visited by the user as part of a user profile, use data stored in the user profile (or augment this data with data provided by the user via answers to prompts displayed on the mobile computing device) to calculate a homeowners insurance quote, handle subsequent insurance claims, etc.

In one aspect, a computer-implemented method of displaying information on a mobile computing device may be provided. The method may include: (1) receiving, by the mobile computing device, transmitter identifying data broadcasted from a transmitter positioned at a predetermined location associated with a dwelling when the mobile computing device is within a threshold range (such as within a threshold range associated with distance, range, proximity, reception, signal strength, bandwidth, and/or power, for example) of the transmitter; (2) sending, by the mobile computing device, the transmitter identifying data to an external computing device via a communication network, the external computing device correlating the transmitter identifying data with information to be displayed on the mobile computing device upon receiving the transmitter identifying data; (3) receiving, by the mobile computing device, the information to be displayed; and/or (4) displaying, by the mobile computing device, the information. The information may include a description of selling (and/or other) features for the dwelling that are associated with the predetermined location. The method may include using the information for insurance-related or financial-related purposes, such as obtaining insurance quotes or a home loan. The method may include additional, fewer, or alternate actions, including those discussed elsewhere herein.

In another aspect, a non-transitory computer readable media may be described having instructions stored thereon in a mobile computing device to display information thereon that, when executed by a processor, cause the processor to: (1) receive transmitter identifying data broadcasted from a transmitter positioned at a predetermined location associated with a dwelling when the mobile computing device is within a threshold range of the transmitter; (2) send the transmitter identifying data to an external computing device via a communication network, the external computing device correlating the transmitter identifying data with information to be displayed on the mobile computing device upon receiving the transmitter identifying data; (3) receive the information to be displayed; and/or (4) display the information. The information may include a description of selling (and/or other) features for the dwelling that are associated with the predetermined location. The information may be used for insurance or financial-related purposes. The non-transitory computer readable media may include additional, fewer, or alternate instructions, including those discussed elsewhere herein.

In yet another aspect, a mobile computing device may be described including a communication unit configured to: (1) receive transmitter identifying data broadcasted from a transmitter positioned at a predetermined location associated with a dwelling when the mobile computing device is within a threshold range of the transmitter; (2) send the transmitter identifying data to an external computing device via a communication network, the external computing device correlating the transmitter identifying data with information to be displayed on the mobile computing device upon receiving the transmitter identifying data; and/or (3) receive the information to be displayed. The mobile computing device may also include a graphics processing unit (GPU) configured to cause the information to be displayed on the mobile computing device. The information may include a description of selling features for the dwelling that are associated with the predetermined location. The home or selling feature information may be used for insurance and/or financial-related purposes. The mobile computing device may include additional, fewer, or alternate components, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 is a block diagram of an exemplary location triggering system 100 in accordance with an exemplary aspect of the present disclosure;

FIG. 2 is a block diagram of an exemplary mobile computing device 200 in accordance with an exemplary aspect of the present disclosure;

FIG. 3A illustrates an exemplary mobile computing device home screen 300 in accordance with an exemplary aspect of the present disclosure;

FIG. 3B illustrates an exemplary mobile computing device application screen 350 in accordance with an exemplary aspect of the present disclosure;

FIG. 4 illustrates an exemplary method 400 in accordance with an exemplary aspect of the present disclosure; and

FIG. 5 illustrates an exemplary method 500 in accordance with an exemplary aspect of the present disclosure.

The Figures depict preferred embodiments for purposes of illustration only. Alternative embodiments of the systems and methods illustrated herein may be employed without departing from the principles of the invention described herein.

### DETAILED DESCRIPTION

The present embodiments relate to, inter alia, displaying information on a mobile computing device regarding one or more selling features of a home directed to a portion of the home corresponding to the location of a transmitter within the home. As further described throughout the disclosure, the mobile computing device may communicate with one or more backend components to access a user profile, collect information from the user entered on the mobile computing device, store data to the user profile, and/or calculate homeowners insurance premium quotes (and/or ultimately handle insurance claims) through these communications.

### Exemplary Systems

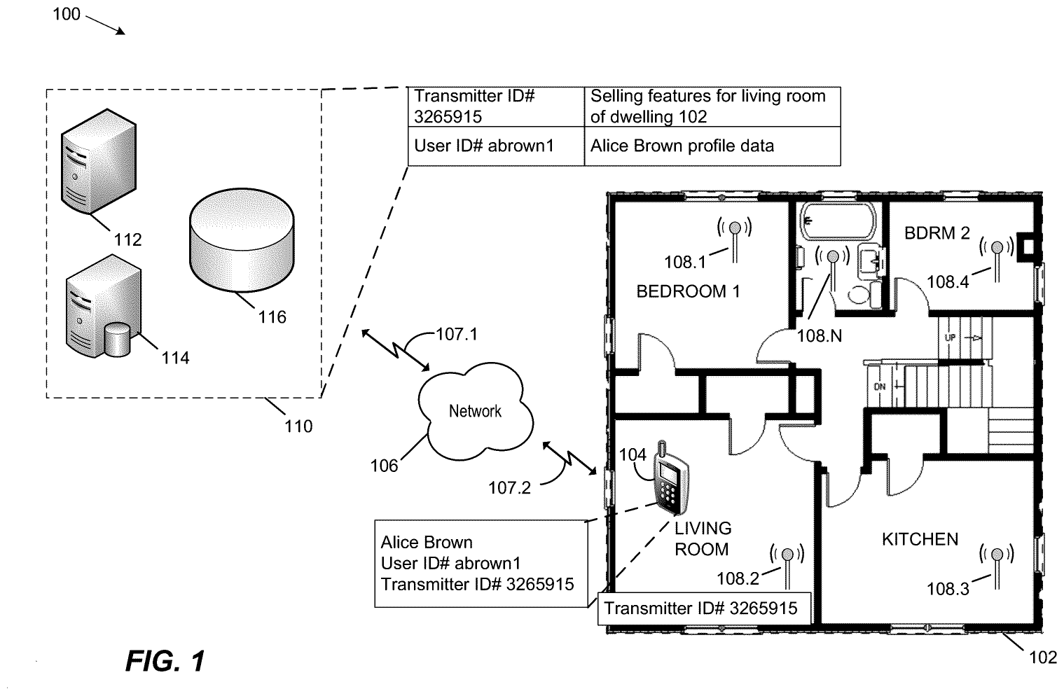

FIG. 1 is a block diagram of an exemplary location triggering system 100 in accordance with an exemplary aspect of the present disclosure. Location triggering system 100 may include a dwelling 102, a mobile computing device 104, a communication network 106, ‘N’ number of transmitters 108.1-108.N located within or otherwise associated with dwelling 102, and one or more back-end components 110.

While a user tours a dwelling 102 with mobile computing device 104, the user may visit the various rooms or other portions of the dwelling 102. As the user does so, mobile computing device 104 may interact with one or more of transmitters 108.1-108.N, which is further discussed below. Upon each interaction, the mobile computing device may display and/or play audio related to the selling (and/or other) features of dwelling 102 corresponding to the current transmitter 108.1-108.N in which the mobile computing device has interacted.

Although dwelling 102 is illustrated as a house in FIG. 1, various aspects of location triggering system 100 may be implemented in any suitable environment in which information is desired to be displayed based upon the user's location within the environment. For example, instead of a house, the dwelling 102 may be a parking garage structure, a warehouse, a single condominium unit within a building of several condominiums, a cabin, a trailer, a hotel room, an apartment within an apartment complex, an arena, an indoor or outdoor venue, etc. The information displayed and/or played via mobile computing device 104 may be tailored to the particular implementation of dwelling 102.

In the present aspects, mobile computing device 104 may be implemented as any suitable computing device, such as a mobile device (e.g., smartphone, tablet, laptop, phablet, netbook, notebook, pager, personal digital assistant (PDA), wearable computing device, smart glasses, smart watch or bracelet, etc.), or other computing device capable of wireless communication or data transmission.

In one aspect, mobile computing device 104 may be configured with suitable hardware and/or software (e.g., one or more applications, programs, files, etc.) to communicate with one or more of transmitters 108.1-108.N. Additionally or alternatively, mobile computing device 104 may be configured with suitable hardware and/or software to communicate with one or more backend components 110 via communication network 106.

In the present aspects, communication network 106 may be implemented as any suitable network configured to facilitate communications between mobile computing device 104 and one or more of backend components 110. Communication network 106 may facilitate data communications in accordance with any suitable number and type of compatible communication protocols. Thus, links 107.1 and 107.2 may represent wired links, wireless links, or any suitable combination thereof.

For example, communication network 106 may include one or more telecommunication networks, nodes, and/or links used to facilitate data transfers, and may facilitate a connection to the Internet for devices connected thereto. Accordingly, communication network 106 may include any suitable number and type of interconnected network components that form an aggregate network system, such as dedicated access lines, plain ordinary telephone lines, satellite links, cellular base stations, public switched telephone networks (PSTN), a wireless telephony network (e.g., GSM, CDMA, LTE, etc.), a Wi-Fi network (e.g., via one or more IEEE 802.11 Standards), a WiMAX network, a proprietary network, a secure public internet, a mobile-based network, a virtual private network, etc., or any suitable combination thereof.

In the present aspects, each of transmitters 108.1-108N may be implemented as any suitable transmitter configured to facilitate communications between transmitter 108 and computing device 104 using any suitable number and type of communciation protocols. One or more transmitters 108.1-108.N may be configured to transmit signals in accordance with their respective communication protocols using any suitable recurring schedule, such as one signal transmission every 10 seconds, one signal transmission every 30 seconds, etc. Examples of suitable communication protocols may include communications conforming to IEEE Standards, personal area network (PAN) protocols, (e.g., BLUETOOTH low energy, or BLE), Wi-Fi protocols, radio frequency identification (RFID) and/or a near field communication (NFC) protocols, etc. Accordingly, each of transmitters 108.1-108.N may be implemented with any suitable number of power sources, wireless transmitters, wireless receivers, wireless transceivers, processors, memories, etc., to facilitate this functionality.

Transmitters 108.1-108.N may be configured to transmit parameters as part of their respective signal transmissions. These parameters may include, for example, transmitter identifying data such as unique identifiers, location identifiers, a dwelling address, latitude and longitude coordinate values, etc. The identifying data may include data to specify the specific location within the dwelling, a dwelling address, etc. These parameters may then be subsequently used to correlate each transmitter 108 to a location within dwelling 102 when received by mobile computing device 104. As shown in FIG. 1, an example of transmitter identifying data for transmitter 108.2 is shown as “3265915.”

In one aspect, one or more transmitters 108.1-108.N may be implemented as iBeacons, which have been developed by Apple, Inc. In some aspects, transmitters 108.1-108.N may be configured to operate in an “advertising mode,” in which transmitters 108.1-108.N transmit but do not receive communications. In other aspects, transmitters 108.1-108.N may be configured to transmit and receive communications from other communication devices, such as mobile computing device 104, for example. Aspects in which transmitters 108.1-108.N operate in an advertising mode may be particularly useful when implemented as devices utilizing a battery power source, as these configurations advantageously reduce power consumption compared to bidirectional communications.

One or more of transmitters 108.1-108.N may be positioned at various different predetermined locations within, or otherwise associated with, dwelling 102. For example, as shown in FIG. 1, transmitter 108.1 is located in a first bedroom, transmitter 108.2 is located in the living room, transmitter 108.3 is located in the kitchen, and transmitter 108.4 is located in a second bedroom. Any suitable number of transmitters 108 may be deployed within dwelling 102, and more than one transmitter 108 may be located in the same room. For example, a bedroom may include two transmitters 108 corresponding to selling features associated with different portions of the bedroom (e.g., a city skyline view from a window and a luxurious custom closet).

Mobile computing device 104 may be configured to initially detect a signal transmission from one or more transmitters 108 and to determine its proximity to the detected transmitter using any suitable techniques. That is, a mobile application installed on mobile computing device 104 may actively “listen” for the recurring signal transmissions. Upon receiving a recognized signal transmission, mobile computing device 104 may determine a range between itself and the detected transmitter. By comparing this range to a trigger threshold, mobile computing device 104 may be configured to determine if the calculated range exceeds the trigger threshold (such as distance, range, proximity, reception, signal strength, bandwidth, and/or power thresholds, for example) and, if so, to execute various actions, which are further discussed below.

To provide an illustrative example, one or more of transmitters 108.1-108.N may be configured to transmit a universally unique identifier (UUID) in accordance with the iBeacon standard, which is the BLE 4.0 specification at the time of this writing. In accordance with such aspects, the transmitted parameters may also include data representative of calibrated receive power information, which may indicate a calibrated received signal strength indicator (RSSI) measured 1 meter from the transmitter by a standard mobile computing device. By broadcasting this information, mobile computing device 104 may compare the RSSI of a received signal transmission to the calibrated receive power information and use this ratio to estimate its proximity and/or range to a respective transmitter 108.

In the present aspects, mobile computing device 104 may be configured to determine a range between itself and one or more transmitters 108 based upon the far, near, and immediate ranging included in the iBeacon standard. Continuing this example, mobile computing device 104 may be configured to utilize one of these ranges (e.g., the immediate range) as a trigger threshold causing mobile computing device 104 to execute one or more actions. Any suitable value or range of values may be used as a trigger threshold based upon, for example, the layout of dwelling 102, the number of transmitters 108.1-108.N deployed within dwelling 102, etc.

To provide additional examples, mobile computing device 104 may be configured to detect a range between itself and one or more transmitters 108 using techniques implementing signal attenuation measurements and/or signal strength measurements incorporating propagation loss calculations, by implementing propagation time of arrival (ToA) and time of departure (ToD) timestamps generated via two-way communications between mobile computing device 104 and one or more transmitters 108, etc.

In some aspects, upon receiving a signal from one or more transmitters 108.1-108.N and determining its proximity thereto, mobile computing device 104 may determine the appropriate actions to perform and execute these actions independently, i.e., without communicating with one or more backend components 110. But in other aspects, upon receiving a signal from one or more transmitters 108.1-108.N and determining its proximity thereto, mobile computing device 104 may communicate with one or more back end components 110 to determine the appropriate actions to perform and to execute these actions as instructed by one or more backend components 110.

Back-end components 110 may include any suitable number of components configured to receive data from and send data to mobile computing device 104 via communication network 106 using any suitable number of wired and/or wireless links and in accordance with any suitable number and type of communication protocols. Back-end components 110 may be configured to execute one or more applications to facilitate one or more aspects of the disclosure as further discussed herein. Back-end components 110 may include one or more external computing devices such as server 112, a database server 114, and/or a database 116.

Furthermore, although FIG. 1 illustrates back-end components 110 as incorporating three different types of back-end components, back-end components 110 may include any suitable number and type of back-end components to facilitate the appropriate functions of the aspects as described herein. For example, although illustrated as single devices in FIG. 1, one or more portions of server 112, database server 114, and/or database 116 may be implemented as devices that share the same physically location, and/or as one or more devices spanned across different locations as a shared database structure (e.g. cloud storage).

For example, database server 114 may be implemented as any suitable number and type of servers that may be configured to access data from database 116, which may store any suitable type of data such as user profile data, and which is further discussed below. To provide another example, server 112 may be implemented as any suitable number and type of web servers configured to provide Internet communications to mobile computing device 104, to process application programming interface (API) service calls, and/or to support one or more applications installed on mobile computing device 104. One or more backend components 110 may be configured to store and/or access secure data that is of a private, proprietary, and/or sensitive nature, such as user profile data, for example. As a result, the present aspects include back end components 110, communication network 106, and/or mobile computing device 104 implementing appropriate security protocols, such as encryption, secure links, network authentication, firewalls, etc., to appropriately protect and secure sensitive and/or private data.

Database 116 may be configured to store any suitable type of relevant data as described in the aspects herein related to the operation of location triggering system 100. In the present aspects, one or more other back-end components 110 may communicate with database 116 to store data to and/or read data from database 116 as needed to facilitate the appropriate functions of the aspects as described herein.

In the present aspects, upon installing and launching an application installed on mobile computing device 104, the user may be prompted to enter login information to create and/or access the user's profile data from one or more back-end components 110. This profile data may correspond to information generated or entered by the user when initially installing the application or when the user initially registered an account with the relevant party (e.g., a realtor, an insurer, etc.) which may be implemented, for example, as a registration process via a website, over the phone, etc. User profile data may be stored in one or more backend components 110 and accessed via a user's logon credentials (e.g., user identifying data such as a user's identifier (ID) and password) provided from any suitable device (e.g., mobile computing device 104), for example, via an API service call placed from mobile computing device 104. User profile data may additionally or alternatively be accessed by appropriate personnel to determine user trends, preferences, and/or for other marketing purposes.

User profile data may include any suitable type of data based upon the type of services provided via the relevant installed application. For example, if the application installed on mobile computing device 104 is used by a realtor agency, then the user's profile data may include contact information, desired search locations, search parameters (e.g., a number of bedrooms, garages, etc.), price ranges, dwellings visited by the user, etc. To provide another example, if the application developer is an insurer, then the user's profile data may include contact information, credit information, risk profile data, calculated homeowner's insurance premium quotes, relevant data used for insurance underwriting or insurance claims, etc.

For example, as shown in FIG. 1, a user ID for a user Alice Brown is represented as “abrown1,” and may be stored in mobile computing device 104 upon installation of the relevant application onto mobile computing device 104. Mobile computing device 104 may also store a password associated with the profile data corresponding to the user abrown 1, so Alice Brown's profile data may be retrieved from one or more backend components 110 by mobile computing 104 via communications over communication network 106 (e.g., via links 107.1 and 107.2).

Again, upon mobile computing device 104 detecting its proximity to one or more transmitters 108, mobile computing device 104 may execute one or more actions. Mobile computing device 104 may determine an action to execute independently or via communications with one or more backend components 110. In aspects in which mobile computing device 104 communicates with one or more backend components 110 to determine the action to execute, mobile computing device 104 may receive, store, and/or transmit the identifying data received from a proximate transmitter 108 and/or the user's logon credentials to one or more backend components 110 as part of an API service call.

One or more of backend components 110 may receive and process the API service call to obtain the identifying data (and the logon credentials, if sent) and correlate the identifying data to the location of the respective transmitter within dwelling 102. In the example shown in FIG. 1, identifying data ID 3265915 corresponds to a transmitter 108 located in the living room of dwelling 102. Once the location within dwelling 102 has been determined, one or more backend components 110 may identify, retrieve, and/or access one or more selling features of the living room in dwelling 102.

One or more backend components 110 may additionally or alternatively store and/or access any other suitable type of information regarding dwelling 102 using any combination of user profile data, third party data, publicly accessible data, etc., such as a postal address, pricing information, multiple listing service (MLS) data, etc. The selling features may be associated with the identifying data through any suitable correlation and/or lookup techniques. The selling features may include those features of dwelling 102 specific to the living room, such as, for example, information regarding recent renovations; details about the age or type of a fireplace; the measurements of the room; the brand and size of windows in the living room; the number of doors and type of doors leading to the room, the type of flooring, tile, or carpeting; the type of ceiling and/or lighting; etc.

Once this information is identified, one or more backend components may send the selling features data and/or any suitable commands to mobile computing device 104 in any suitable format. This data may include, for example, a features video to be played on mobile computing device 104, one or more images to be displayed, text to be displayed describing the selling features, audio to be played, etc. Upon receiving this information via one or more backend components 110, mobile computing device 104 may perform a relevant action based upon the received data and/or the commands.

This process may be repeated as a user tours dwelling 102, such that as mobile computing device 104 comes within a threshold range of other transmitters 108, it triggers mobile computing device 104 to automatically provide selling features information for each room without user intervention.

### Exemplary Triggering Processes

Again, in some aspects, mobile computing device 104 may receive transmissions from one or more transmitters 108.1-108.N and communicate with one or more backend components 110 to display selling features regarding various portions of dwelling 102. But in other aspects, mobile computing device 104 may be configured to display selling features without communicating with backend components 110. For example, mobile computing device 104 may store this data and perform a correlation between the identifying data and the selling features locally. In accordance with such aspects, the applicable data may be downloaded, installed, or otherwise stored to mobile computing device 104, for example, upon installation of the relevant mobile application.

In still other aspects, one or more transmitter's 108.1-108.N may be implemented as RFID or NFC devices. In accordance with such aspects, a user may tap or touch mobile computing device 104 to a transmitter 108 (e.g., hold mobile computing device 104 an inch or two from the transmitter) to receive information regarding selling features of the portion of dwelling 102 where the transmitter 108 is located. In some implementations of this aspect, mobile computing device 104 may receive the selling feature information via RFID and/or NFC communications with a compliant transmitter 108. In other implementations of this aspect, mobile computing device 104 may receive the identifying data from a compliant transmitter 108 and communicate with one or more backend components 110 to obtain and display the selling features.

In further aspects, one or more transmitters 108.1-108.N may be omitted. In accordance with such aspects, mobile computing device 104 may communicate with one or more backend components in a similar manner as if transmitters 108.1-108.N were present to display selling features, but the triggering may be performed in another manner. For example, a geofence may be associated with dwelling 102 and stored in one or more backend components 110. Upon entering this geofence, one or more backend components 110 may send data to mobile computing device 104, causing mobile computing device 104 to display selling features or other relevant information to a potential homebuyer. Although these aspects may not provide selling features at a room level granularity, they advantageously eliminate the need for external hardware.

To provide another example whereby transmitters 108 may be omitted, one or more access points may be associated with dwelling 102 and an Internet Protocol (IP) address of the access point stored in one or more backend components 110. The one or more access points are not shown in FIG. 1 for purposes of brevity. Upon communicating with one or more access points, one or more backend components 110 may send data to mobile computing device 104, causing mobile computing device 104 to display selling features or other relevant information. Again, these aspects may not provide selling features at the room level, but may cause selling features to be displayed that are associated with the location of dwelling 102 corresponding to each access point that is detected.

### An Exemplary Mobile Computing Device

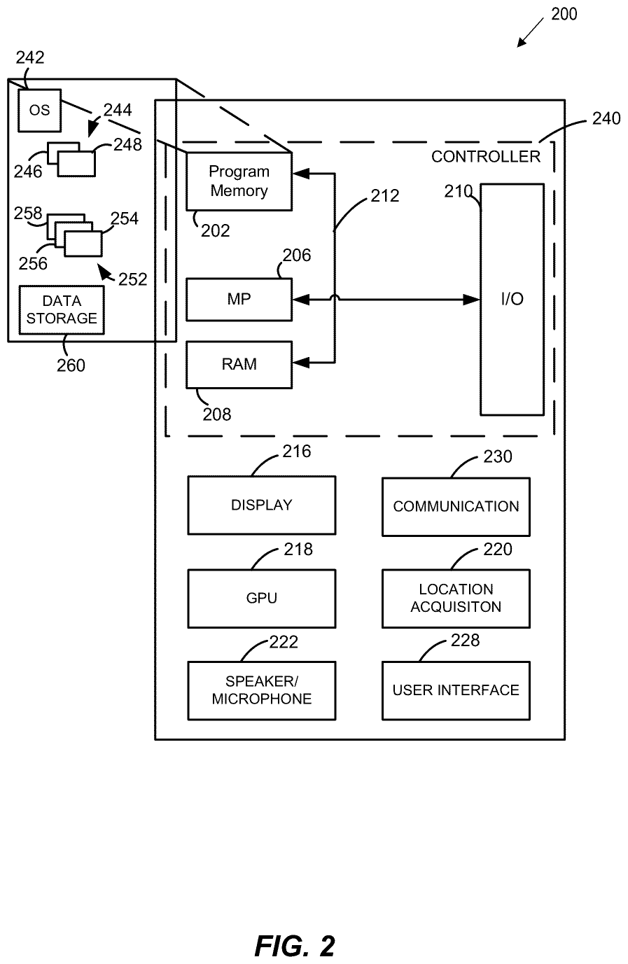

FIG. 2 is a block diagram of an exemplary mobile computing device 200 in accordance with an exemplary aspect of the present disclosure. Mobile computing device 200 may be implemented as any suitable computing device. In one aspect, mobile computing device 200 may be an implementation of mobile computing device 104, for example, as shown in FIG. 1. Mobile computing device 200 may include a display 216, a graphics processing unit (GPU) 218, a location acquisition unit 220, a speaker/microphone 222, a user interface 228, a communication unit 230, and a controller 240.

Controller 240 may include a program memory 202, a microprocessor (MP) 206, a random-access memory (RAM) 208, and an input/output (I/0) interface 210, each of which may be interconnected via an address/data bus 212. Controller 240 may be implemented as any suitable type and/or number of processors, such as a host processor of mobile computing device 200, for example. In some aspects, controller 240 may be configured to communicate with additional data storage mechanisms not shown in FIG. 2 for purposes of brevity (e.g., one or more hard disk drives, optical storage drives, solid state storage devices, etc.) that may reside within and/or are otherwise associated with mobile computing device 200.

Program memory 202 may store data used in conjunction with one or more functions performed by mobile computing device 200 to facilitate the interaction between mobile computing device 200 and one or more other devices. For example, program memory 202 may store one or more programs, applications, algorithms, etc. that, when executed by controller 240, facilitate the interaction between mobile computing device 200 and one or more transmitters (e.g., transmitters 108.1-108.N), one or more networks (e.g., communication network 106), one or more back end components (e.g., backend components 110), etc.

In various aspects, program memory 202 may be implemented as a non-transitory tangible computer readable media configured to store computer-readable instructions, that when executed by controller 240, cause controller 240 to perform various acts. Program memory 202 may include an operating system 242, one or more software applications 244, and one or more software routines 252. To provide another example, program memory 202 may include other portions to store data that may be read from and written to by MP 206, such as data storage 260, for example.

In one aspect, one or more MPs 206 may be configured to execute one or more of software applications 244, software routines 252 residing in program memory 202, and/or other suitable software applications. For example, operating system 242 may be implemented as any suitable operating system platform depending upon the particular implementation of mobile computing device 200. For example, operating system 242 may be implemented as a mobile OS platform such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively.

In one aspect, data storage 260 may store data such as application data for the one or more software applications 244, routine data for the one or more software routines 252, user logon credentials, information to be displayed corresponding to a transmitter location, insurance quote calculations, etc.

Display 216 may be implemented as any suitable type of display and may facilitate user interaction with mobile computing device 200 in conjunction with user interface 228. For example, display 216 may be implemented as a capacitive touch screen display, a resistive touch screen display, etc. In various aspects, display 216 may be configured to work in conjunction with controller 240 and/or GPU 218 to display information regarding one or more portions of a dwelling, to display prompts to a user, to display one or more fields for user input, to display an insurance premium quote, etc.

Location acquisition unit 218 may be configured to generate geographic location data utilizing any suitable global positioning techniques. For example, location acquisition unit 218 may communicate with one or more satellites and/or wireless transmitters to determine a location of mobile computing device 200. Location acquisition unit 218 may function independently or in conjunction with one or more components of mobile computing device 200. For example, location acquisition unit 218 may work in conjunction with communication unit 230 to utilize cellular location data received via communications unit 230 and implement “Assisted Global Positioning System” (A-GPS). To provide additional examples, location acquisition unit 218 may work as an independent unit implementing satellite GPS, or any other suitable global positioning protocol (e.g., the GLONASS system operated by the Russian government, the Galileo system operated by the European Union, etc.) to determine a geographic location of mobile computing device 200.

Communication unit 230 may be configured to facilitate communications between mobile computing device 200 and one or more other devices, such as transmitters, networks, back end components, etc. As previously discussed with reference to FIG. 1, mobile computing device 200 may be configured to communicate with these other devices in accordance with any suitable number and type of communication protocols. Thus, in various aspects, communication unit 230 may be implemented with suitable hardware, firmware, and/or software to support any suitable number and type of communication protocols in accordance with the various aspects described herein.

Communication unit 230 may be configured to support separate or concurrent communications, which may be the same type of communication protocol or different types of communication protocols. For example, communication unit 230 may be configured to facilitate communications between mobile computing device 200 and one or more backend components via a cellular communications protocol while facilitating communications between mobile computing device 200 and a transmitter via a BLUETOOTH communications protocol.

Additionally or alternatively, aspects include communication unit 230 being configured to send and/or receive data upon one or more trigger conditions being satisfied, as previously discussed with reference to FIG. 1. Communication unit 230 may be configured to function independently or in conjunction with one or more components of mobile computing device 200 to determine if and when a trigger condition has been satisfied. For example, communication unit 230 may perform signal strength measurements independently and/or in conjunction with controller 230 to determine whether a respective transmitter signal strength exceeds a threshold strength. If so, communication unit 230 may send identifying data received from a transmitter to one or more backend components.

To provide another example, communication unit 230 and/or controller 240 may receive geographic location information from location acquisition unit 218. For example, communication unit 230 and/or controller 240 may determine whether mobile computing device is within a geofence perimeter corresponding to a dwelling location by comparing the geographic location data to the geofence perimeter. This geofence perimeter data may be stored locally in mobile computing device 200 (e.g., data storage 260) and/or accessed remotely from one or more backend components. If communication unit 230 and/or controller 240 determine that mobile computing device 200 has entered the geofence perimeter associated with a dwelling, communication unit 230 and/or controller 240 may communicate with one or more backend components to receive dwelling information and display this information via display 216.

Speaker/microphone 222 may be configured as one or more separate devices. Speaker/microphone 222 may include a microphone configured to detect sounds and to convert detected sounds to data suitable for communications via communications unit 230. Speaker/microphone 222 may additionally or alternatively include a speaker configured to play sounds in response to data received from one or more components of computing device 200 (e.g., controller 240 and/or communication unit 230). In one aspect, speaker/microphone 222 may be configured to play audible information including selling features of a dwelling, as previously discussed with respect to FIG. 1.

User-interface 228 may be implemented as any suitable device configured to collect user input, such as a “soft” keyboard displayed on display 216 of mobile computing device 200, a keyboard attached to mobile computing device 200, an external keyboard communicating via a wired or a wireless connection (e.g., a BLUETOOTH keyboard), an external mouse, etc.

In one aspect, software applications 244 may include a location-based triggering application 246, which may be implemented as a series of machine-readable instructions for executing one or more functions described herein. In another aspect, location-based triggering application 246 may cooperate with one or more other hardware or software components of mobile computing device 200 to perform these functions.

For example, location-based triggering application 246 may include instructions for performing tasks such as determining a geographic location of mobile computing device 200 (e.g., via communications with location acquisition unit 230), receiving signals broadcasted from one or more transmitters (e.g., transmitters 108.1-108.N), measuring a signal strength of signals transmitted from one or more transmitters, communicating with one or more transmitters to receive dwelling information to be displayed (e.g., in NFC embodiments in which mobile computing device is tapped to a transmitter so configured), determining whether a trigger condition has been met (e.g., by entering a geofence perimeter, when a transmitted signal strength exceeds a threshold, determining bandwidth or power levels, determining distances or ranges, etc.), communicating with and/or placing API services calls to one or more back end components, receiving dwelling information to be displayed from one or more backend components, sending user logon credentials to one or more backend components, receiving calculated insurance premium quotes from one or more backend components, displaying and/or playing information related to the dwelling and/or a specific dwelling location associated with a specific transmitter, displaying one or more prompts, facilitating user interaction with mobile computing device 200, facilitating communications between computing device 200 and one or more other devices in conjunction with communication unit 230, etc.

Software applications 244 may include a web browser 248. In some aspects, web browser 248 may be a native web browser application, such as Apple's Safari®, Google Android™ mobile web browser, Microsoft Internet Explorer® for Mobile, Opera Mobile™, etc. In other embodiments, web browser 248 may be implemented as an embedded web browser. Regardless of the implementation of web browser 248, various aspects include web browser 248 being implemented as a series of machine-readable instructions for interpreting and displaying web page information received from one or more backend components (e.g., backend components 110, as shown in FIG. 1). This web page information may be utilized in conjunction with location-based triggering application 246 to perform one or more function of the aspects as described herein.

In one embodiment, software routines 252 may include a trigger detection routine 254, an action execution routine 256, and/or a feedback routine 258. Trigger detection routine 254 may include instructions, that when executed by controller 240, facilitate monitoring and/or collecting data received via one or more components of mobile computing device 200 to determine whether one or more trigger conditions have been satisfied.

In some aspects, trigger detection routine 254 may be executed locally by controller 204 to make this determination. In other aspects, trigger detection routine 254, upon being executed by controller 204, may communicate with one or more backend components to make this determination. When communicating with one or more backend components, the determination of whether one or more trigger conditions have been satisfied may be performed using any suitable combination of data collected locally via one or more components of mobile computing device 200 and/or data received via the one or more backend components.

Action execution routine 256 may include instructions, that when executed by controller 240, facilitate the execution of one or more relevant actions based upon the type of triggering event detected via trigger detection routine 254 and/or the action assigned to a detected trigger condition by location-based triggering application 246. Action execution routine 256 may, when executed by controller 240, cause one or more actions to be executed via one or more components of mobile computing device 200.

Feedback routine 258 may include instructions, that when executed by controller 240, support user interaction with mobile computing device 200. For example, controller 240 may execute instructions stored in feedback routine 258 to obtain information from a user and/or to provide the user with information received from one or more backend components. To provide another example, controller 240 may execute instructions stored in feedback routine 258 to display one or more prompts, to process user requests for additional information on a dwelling and/or for an insurance premium quote or an insurance policy approval (and/or home loan quote or approval), to communicate such requests with one or more backend components, to cause user profile data to be stored as part of a user profile, to view user profile data, etc.

Although each of the components in FIG. 2 are illustrated as separate units or modules, any components integrated as part of mobile computing device 200 may be combined and/or share functions. For example, controller 240, GPU 218, and program memory 206 may be integrated as a single processing unit. Furthermore, although connections are not shown between the individual components of mobile computing device 200, mobile computing device 200 may implement any suitable number of wired and/or wireless links to facilitate communication and interoperability between these components.

For example, program memory 206, communication unit 230, and/or display 216 may be coupled via wired buses and/or wireless links to controller 240 and/or GPU 218 to facilitate communications between these components and to enable these components to accomplish their respective functions as described throughout the present disclosure. Furthermore, although FIG. 2 illustrates mobile computing device 200 having a single program memory 206, mobile computing device 200 may implement any suitable number and/or combination of memory systems.

Additionally, although FIG. 2 depicts controller 240 as including one program memory 202, one MP 206, and one RAM 208, controller 240 may include any suitable number of program memories 202, MPs 206, and RAMs 208. Furthermore, although FIG. 2 depicts controller 240 as having a single I/O interface 210, controller 240 may include any suitable number and/or types of I/O interfaces 210. In various aspects, controller 240 may implement RAM(s) 208 and program memories 202 as any suitable type of memory, such as non-transitory computer readable memories, semiconductor memories, magnetically readable memories, and/or optically readable memories, for example.

### Installation & Execution of a Location-Based Triggering App

Controller 240 and/or GPU 218 may execute location-based triggering application 246 in conjunction with one or more of trigger detection routine 254, action execution routine 256, and/or feedback routine 258 to facilitate various aspects of the present disclosure.

To accomplish these functions, in some aspects, software applications 244 and/or software routines 252 may reside in program memory 202 as default applications that may be bundled together with the OS of mobile computing device 200. For example, web browser 248 may be part of software applications 244 that are included with OS 242 implemented by mobile computing device 200.

In other aspects, these functions may be accomplished by software applications 244 and/or software routines 252 being installed on mobile computing device 200 as one or more downloaded files, such as an executable package installation file downloaded from a suitable application store via a connection to the Internet. For example, trigger detection routine 254, action execution routine 256, and/or feedback routine 258 may be stored to suitable portions of program memory 202 upon installation of a package file downloaded in such a manner.

Examples of package download files may include downloads via the iTunes store, the Google Play Store, the Windows Phone Store, downloading a package installation file from another computing device, etc. Once downloaded, location-based triggering application 246 may be installed on mobile computing device 200 via an installation package such that trigger detection routine 254, action execution routine 256, and/or feedback routine 258 may also be installed and stored in a suitable portion of program memory 202.

Upon performing an initial setup of location-based triggering application 246 on mobile computing device 200, controller 240 and/or GPU 218 may execute one or more routines 252 as foreground and/or background processes. For example, location-based triggering application 246 may instructions for GPU 218 cause display 216 to display a corresponding interactive icon. A user may perform the setup by initially opening location-based triggering application 246 using, for example, an appropriate gesture, such as tapping his finger on the interactive icon.

Upon launching the application, a user may enter her logon credentials, which may be sent to one or more back-end components to provide access to the user's profile data via communications between mobile computing device 200 and one or more backend components. A user may use display 216 to view details associated with and/or to make changes to her user profile, which may optionally be stored in any suitable portion of program memory 202, RAM 208, etc.

Once a user has entered her logon credentials, location-based triggering application 246 may execute one or more background processes. For example, location-based triggering application 246 may cause mobile computing device 200 to actively “listen” for transmissions from one or more transmitters without user intervention in accordance with a certain communication protocol (e.g., a BLUETOOTH low energy protocol). To provide another example, location-based triggering application 246 may cause mobile computing device 200 to periodically store geographic location data corresponding to a location of mobile computing device 200 without user intervention (e.g., via location acquisition unit 220) and to compare this geographic location data to one or more geofence perimeters (e.g., locally stored or retrieved via communication with one or more backend components). To provide yet another example, location-based triggering application 246 may cause mobile computing device 200 to communicate with a transmitter to retrieve information to be displayed via display 216 and/or played via speaker/microphone 222 in accordance with a certain communication protocol (e.g., an NFC protocol).

### Exemplary Functionality of a Location-Based Triggering App

Again, upon installing location-based triggering application 246, a user may perform an initial setup process whereby a user profile is created and stored on one or more backend components. In various aspects, the location-based triggering application 246 may facilitate various functions being performed via mobile computing device 200.

To provide an illustrative example, a user may visit a dwelling having multiple transmitters positioned at various locations therein. When mobile computing device 200 is within a threshold range or distance of a transmitter (and/or when other thresholds have been satisfied, such as location, signal strength, broadband, power, signal quality, or other thresholds), mobile computing device 200 may broadcast identifying data received from the transmitter and user logon credentials associated with the user profile data. The identifying data and user logon credentials may be received by one or more backend components. The one or more backend components may correlate the identifying data to specific information regarding selling features at a location within the dwelling at the location of the transmitter. The one or more backend components may also access the user's profile data to store the identifying data or other data that may be obtained by referencing the identifying data, such as a dwelling address, for example. The one or more backend components may send information back to mobile computing device 200 indicating the selling features and/or an action to be executed on mobile computing device 200 upon receiving the information, such as playing a video, playing a sound, displaying an image, etc. In this way, as a user approaches each transmitter located within a dwelling, the user can observe selling features of the dwelling relevant to the location of each transmitter via mobile computing device 200.

To provide another illustrative example, a user may visit a dwelling associated with a geofenced perimeter. The dwelling may or may not have transmitters positioned at various locations therein. Mobile computing device 200 may periodically broadcast its geographic location to one or more backend components, which in turn may determine whether mobile computing device 200 is within the geofenced perimeter. Additionally or alternatively, mobile computing device 200 may independently make this determination. In either case, upon entering the geofenced perimeter, mobile computing device 200 may execute one or more actions. These actions may be received by mobile computing device 200 from one or more backend components that have correlated the geofence location to specific information regarding the dwelling. These actions may additionally or alternatively be determined by mobile computing device 200 by storing the dwelling information locally and correlating the geofence perimeter to this information. In either case, upon entering the geofenced perimeter, mobile computing device 200 may execute one or more actions such as playing a video, playing a sound, displaying images, etc., regarding selling features of the dwelling upon entering the dwelling's geofenced perimeter.

To provide yet another illustrative example, mobile computing device 200 may solicit feedback from a user and/or provide a user with additional information regarding a dwelling. This feedback may include, for example, asking the user whether he would like to obtain a homeowner's insurance premium quote, feedback regarding what the user may have liked or not liked about the dwelling, feedback requesting the user's opinion on the pricing of the dwelling, etc. Continuing this example, a user may be prompted whether he would like to obtain a homeowner's insurance premium quote for a visited dwelling. If a user responds that he would, mobile computing device 200 may communicate with one or more backend devices to calculate this quote and to send the quote data to mobile computing device 200, which in turn displays this information. The one or more backend components may calculate the homeowner's insurance premium quote using data in the user's profile and the dwelling address, the latter of which may be identified from the location of mobile computing device 200 (e.g., via a reverse geocoding operation) and/or from the identifying data transmitted by one or more transmitters.

Because a certain minimum amount of information may be needed to calculate a homeowner's quote, the one or more backend components may determine whether adequate information is stored in the user's profile for such a calculation. If not, the one or more backend components may continue to communicate with mobile computing device 200, which may prompt a user for the necessary data and communicate this data back to the one or more backend components so that the homeowner's insurance premium quote may be calculated. Additionally or alternatively, one or more backend components 110 may further correlate the transmitter identifying data to a dwelling address and store the dwelling address as part of the user profile associated with the user identifying data so that it may be subsequently used, for example, to calculate homeowners insurance premium quotes; for a user to view a history of visited dwellings; generating a home loan quote; generating updated or new insurance policies, premiums, discounts, and/or rates; for underwriting purposes; for handling or resolving home insurance claims that ultimately result from insurance-related events (e.g., fire, wind, hail, and/or water damage), such as determining an estimated worth or replacement cost of the home (or portions thereof) and/or estimate of home damage from an insurance-related event; etc.

In this way, a user may quickly obtain a homeowner's insurance premium quote for a dwelling if the user is particularly interested in the dwelling as a potential purchase. In one aspect, the user may be presented with one or more feedback prompts upon expiration of a threshold period of time since a trigger condition was detected. In this way, a user may likely be prompted after the user has finished looking at the dwelling.

### Exemplary Screenshots of an Alert Notification Application

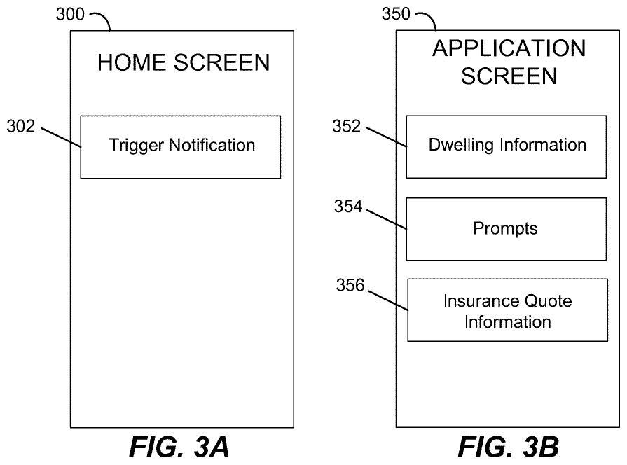

FIG. 3A illustrates an example mobile computing device home screen 300 in accordance with an exemplary aspect of the present disclosure. In various aspects, home screen 300 may be displayed on a mobile computing device, such as mobile computing device 104 or mobile computing device 200, for example, as shown in FIGS. 1 and 2, respectively. In accordance with such aspects, home screen 300 may be displayed as part of a device display, such as display 216, for example, as shown in FIG. 2.

Home screen 300 may be displayed as a default screen on a mobile computing device and may facilitate a lock screen. Lock screens are typically displayed when a user locks the mobile computing device to enter a lock screen mode (e.g., by pressing a physical button). Additionally or alternatively, home screen 300 may be displayed on the mobile computing device when inactive for a threshold period of time. The lock screen prevents a user from using a portion of the mobile computing device functionality. For example, a lock screen might prevent a mobile computing device in a user's pocket from accidentally sending SMS messages or phone calls.

Although lock screens typically limit the functionality of the device when enabled, it may be desirable for certain applications to provide a user with some functionality via the lock screen. For example, if the mobile computing device is used to play music, a lock screen overlay may allow a user to change tracks, pause a track, and/or adjust the volume level without unlocking the phone. In accordance with some aspects, trigger notification 302 may be displayed as part of a home screen and/or lock screen overlay of a mobile computing device, as shown in FIG. 3A.

Although trigger notification 302 may be displayed as part of home screen 300, other aspects include trigger notification 302 being displayed as part of a notification system separate from home screen 300. For example, some mobile phone operating systems (e.g., the Android OS) implement a universal “pull-down” notification system where all incoming notifications are displayed. In these notification systems, new notifications are initially previewed in a notification bar at the top of the phone display, and a user may pull down the notification bar (e.g., by using a swiping gesture) to access the details of any received notifications. In one aspect, trigger notification 302 may be displayed as part of a notification bar type notification.

As previously discussed with reference to FIG. 2, a device running the location-based triggering application may be configured to determine whether a triggering condition has been detected, such as mobile computing device being within a threshold range of a transmitter or entering a geofenced perimeter, for example. In accordance with such aspects, trigger notification 302 is a block diagram representation of what may be generated upon detection of a trigger condition and/or receiving an indication that a trigger condition has been satisfied. Trigger notification 302 may be implemented as any suitable graphic, label, text, description, etc., to convey this to a user. In one aspect, trigger notification 302 may be interactive and may facilitate a user selection via an appropriate gesture (e.g., swiping, tapping, etc.), which is further discussed below.

FIG. 3B illustrates an example mobile computing device application screen 350 in accordance with an exemplary aspect of the present disclosure. In various aspects, application screen 350 may be displayed on a mobile computing device, such as mobile computing device 104 or mobile computing device 200, for example, as shown in FIGS. 1 and 2, respectively. In accordance with such aspects, application screen 350 may be displayed as part of a device display, such as display 216, for example, as shown in FIG. 2.

In some aspects, application screen 350 may be displayed upon a user selecting alert notification 302 from home screen 300 using an appropriate gesture. In other aspects, application screen 350 may be displayed without user intervention when a trigger condition is detected by the mobile computing device.

Application screen 350 may include dwelling information 352, prompts 354, and/or insurance quote information 356. Although application screen 350 is illustrated in FIG. 3B as including each of dwelling information 352, prompts 354, and/or insurance quote information 356, aspects include one or more of dwelling information 352, prompts 354, and/or insurance quote information 356 being displayed at one time as part of application screen 350.

That is, the number and type of information displayed via application screen 350 may be based upon the particular trigger detected by a mobile computing device and/or the particular action to be executed by mobile computing device in response to the detected trigger. For example, if the mobile computing device is within threshold range of a transmitter, home screen 300 may be displayed showing trigger notification 302 briefly (e.g., 1 or 2 seconds) before transitioning to application screen 350, which may include dwelling information 352 corresponding to portions of the dwelling near the transmitter, but not include prompts 354 or insurance quote information 356.

Dwelling information 352 is a block diagram representation of dwelling information that may be displayed for a user. Dwelling information 352 may be implemented as any suitable graphic, label, text, description, etc., to suitably present this information. Again, the dwelling information may include selling features, price information, etc., and may be specific to a location within the dwelling associated with the transmitter that caused trigger notification 302 to be displayed, as shown in FIG. 3A.

Prompts 354 is a block diagram representation of one or more prompts that may be displayed to solicit information from a user. Prompts 354 may be implemented as any suitable graphic, label, text, description, etc., to request information from a user. For example, prompts 354 may include questions asking for a user's feedback on a visited dwelling, whether the user would like a homeowner's insurance premium quote, questions to fill gaps in the information stored in the user's profile data needed to calculate a homeowner's insurance premium quote, questions related to home financing, other insurance-related questions, etc.

Insurance quote information 356 is a block diagram representation of homeowner's insurance quote information that may be displayed to a user. Insurance quote information 356 may be implemented as any suitable graphic, label, text, description, etc., to suitably display this information to a user. For example, insurance quote information 356 may include a monthly homeowner's insurance premium payment, a yearly premium total, various quotes associated with varying levels of insurance coverage and/or other coverage options or add-ons, etc.

### Exemplary Method of Displaying Dwelling Information

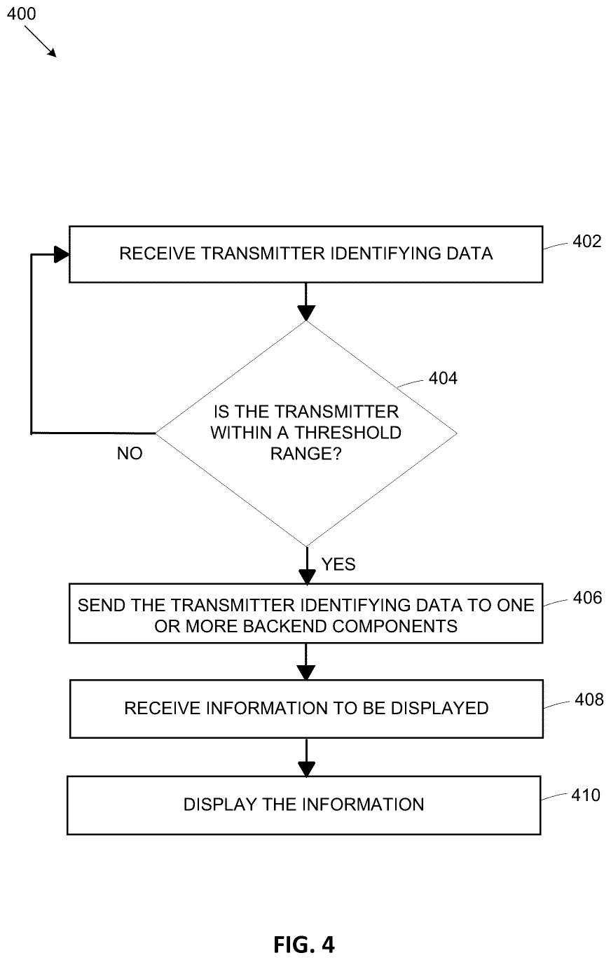

FIG. 4 illustrates an exemplary method 400 in accordance with one aspect of the present disclosure. In the present aspect, method 400 may be implemented by any suitable computing device (e.g., mobile computing device 104 or mobile computing device 200, as shown in FIGS. 1 and 2, respectively). In one aspect, method 400 may be performed by one or more processors, applications, and/or routines, such as any suitable portion of controller 240, software applications 244, and/or software routines 252, for example, as shown in FIG. 2.

Method 400 may start when one or more processors receive transmitter identifying data broadcasted by a transmitter (block 402). Method 400 may include receiving the transmitter identifying data broadcasted from one or more transmitters in accordance with any suitable communication protocols, such as BLUETOOTH low energy protocols, for example (block 402). The transmitter identifying data may include, for example, a UUID transmitted in a broadcasted transmitter signal (block 402).

Method 400 may include one or more processors determining whether the transmitter broadcasting the transmitter identifying data is within a threshold range (block 404). This determination may be made, for example, based upon a whether the signal strength of the transmitted signal meets or exceeds a threshold value (block 404). This determination may also be made, for example, by utilizing ranging methods that are integrated as part of the protocol in which the transmitted signal is received (block 402), such as the signal strength (and/or other wireless communication, data transmission, and/or signal characteristics) exceeding a far, near, or immediate ranging included in the iBeacon standard, for example (block 404). If so, then method 400 may continue (block 406). Otherwise, method 400 may revert back to receiving transmitter identifying data (block 402) and determining whether the signal strength meets or exceeds a threshold value (block 404).

In some aspects, method 400 may continue upon receiving transmitter identifying data regardless of whether the signal meets or exceeds another threshold value—other than the threshold sensitivity that determines whether the transmitted signal is actually received at all (block 404 is omitted).

Method 400 may include one or more processors sending the transmitter identifying data to one or more backend components (block 406). The one or more backend components may be implemented as any suitable remote computing device, such as backend components 110, for example, as shown in FIG. 1 (block 406). Method 400 may include sending the transmitter identifying data to the one or more backend components from a mobile computing device in accordance with any suitable communication protocols, such as cellular protocols, for example (block 406).

Method 400 may include one or more processors receiving information to be displayed (block 408). This information may include, for example, dwelling information such as selling features directed to a portion of a dwelling at the same location or near the location of the transmitter (block 408).

Method 400 may include one or more processors displaying or playing the information (block 410) that was received from one or more backend components (block 406). This information may be displayed and/or played in any suitable manner, such as a video of the information, one or more images of the information, text of the information, an audio track describing the information, etc. (block 410). The method may include additional, less, or alternate actions, including those discussed elsewhere herein.

### Exemplary Method of Displaying Insurance Premiums

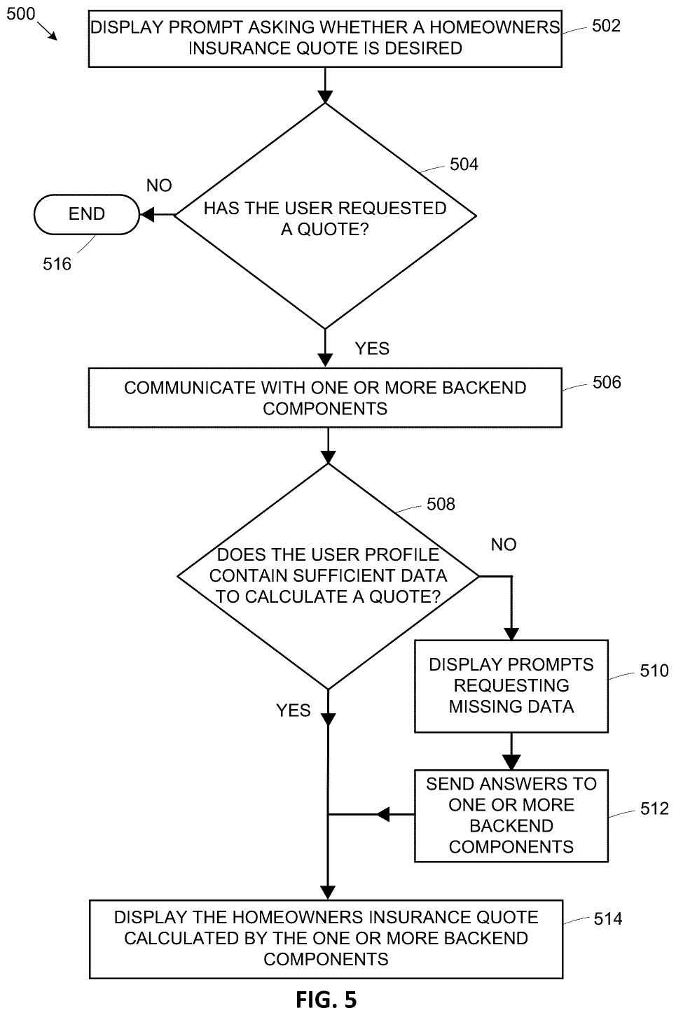

FIG. 5 illustrates an example method 500 in accordance with an exemplary aspect of the present disclosure. In the present aspect, portions of method 500 (or method 500 in its entirety) may be implemented by any suitable local computing device (e.g., mobile computing device 104 or mobile computing device 200, as shown in FIGS. 1 and 2, respectively), while other portions of method 500 may be implemented by any suitable remote computing device (e.g., one or more backend components 110, as shown in FIG. 1). In one aspect, method 500 may be performed by one or more processors, applications, and/or routines, such as any suitable portion of controller 240, software applications 244, and/or software routines 252, for example, as shown in FIG. 2.

Method 500 may start when one or more processors display one or more prompts soliciting a user whether a homeowners insurance premium quote is desired (block 502). Method 500 may include displaying the prompts via any suitable display device (e.g., display 216, as shown in FIG. 2) (block 502). In some aspects, method 500 may display one or more prompts after a threshold period of time has elapsed since a trigger condition has been satisfied (e.g., after 20 minutes has elapsed since identifying data was received, after 30 minutes has elapsed since mobile computing device entered a geofence perimeter associated with a dwelling, etc.) (block 502). In this way, method 500 presents one or more prompts for homeowners insurance when there is a high likelihood that a user has finished touring a dwelling.

Method 500 may include one or more processors determining whether the user desires to obtain a homeowners insurance premium quote (block 504) based upon the user's interaction with the mobile computing device in response to the displayed prompts (block 502). If so, method 500 continues to calculate and display the homeowners insurance premium quote (block 506). Otherwise, method 500 ends, which may include the application screen (as previously illustrated and discussed with reference to FIG. 3B) closing, for example (block 516).

Method 500 may include one or more processors communicating with one or more backend components (block 506). The one or more backend components may be implemented as any suitable remote computing device, such as backend components 110, for example, as shown in FIG. 1 (block 506). Method 500 may include sending the user's logon credentials to the one or more backend components so that a user profile may be accessed (block 506). Method 500 may include sending the user logon credentials to the one or more backend components from a mobile computing device in accordance with any suitable communication protocols, such as cellular protocols, for example (block 506).

Method 500 may include one or more processors determining whether the data included in the user profile, accessed via the logon credentials (block 506) is sufficient to calculate a homeowners insurance premium quote (block 508). This determination may be made, for example, via one or more backend components (block 508). If so, then method 500 may proceed to calculate and send the homeowners insurance premium quote to the mobile computing device, whereupon it will be displayed via the mobile computing device (block 514). Otherwise, method 500 continues to communicate with the mobile computing device to obtain the missing data needed for the calculation of the homeowners insurance premium quote (block 510).

Method 500 may include one or more processors displaying one or more prompts requesting the missing data that is needed to calculate the homeowners insurance premium quote (block 510). This may include, for example, one or more prompts being displayed on the mobile computing device, such as prompts 354, for example, as shown in FIG. 3A. Method 500 may include a mobile computing device receiving an indication of the missing data from the one or more backend components and displaying prompts to solicit this missing data (block 510).

Method 500 may include one or more processors sending the answers to the displayed prompts (block 510) to the one or more backend components (block 512). Method 500 may include the one or more backend components updating the user profile data with the user's answers (block 512).

Once sufficient information may be accessed by the one or more backend components from the user profile data, method 500 may include one or more processors calculating the homeowners insurance premium quote (block 514). This calculation may be performed using any suitable risk assessment techniques, for example, taking into consideration personal data from the user profile, dwelling information obtained via third party and/or public sources, crime statistics associated with the location of the dwelling, etc. (block 514). Upon calculating the homeowners insurance premium quote, the one or more backend components may send the calculated homeowners insurance premium quote to the mobile computing device (block 514), and the mobile computing device may display the homeowners insurance premium quote in any suitable manner (block 514).

The method may include additional, less, or alternate actions, including those discussed elsewhere herein. For instance, after the user has purchase the homeowners insurance and/or home, an insurance-related event may occur at some point in the future. The information in the user profile and/or other data collected regarding the home and home features may be used to handle insurance claims associated with the homeowners insurance policy. For instance the data collected may be used estimate replacement costs and/or estimate repairs for a home and/or damaged portions thereof to facilitate prompt payment of monies to the insured, expedite insurance claim handling , and/or enhance the customer experience after an insurance-related event causes damage to their home.

### Exemplary Methods of Displaying Information on a Mobile Device

In one aspect, a computer-implemented method of displaying information on a mobile computing device may be provided. The method may include: (1) receiving, by the mobile computing device, transmitter identifying data broadcasted from a transmitter positioned at a predetermined location associated with a dwelling when the mobile computing device is within a threshold range of the transmitter (including within the threshold ranges discussed herein, such as ranges based upon distance, proximity, signal strength, other data transmission or signal characteristics, relationships between the mobile computing device and the transmitter, etc.); (2) sending, by the mobile computing device, the transmitter identifying data to an external computing device via a communication network, the external computing device correlating the transmitter identifying data with information to be displayed on the mobile computing device upon receiving the transmitter identifying data; (3) receiving, by the mobile computing device, the information to be displayed; and/or (4) displaying, by the mobile computing device, the information. The information may include a description of selling features for the dwelling that are associated with the predetermined location to facilitate collection of home feature information via wireless communication or data transmission for insurance-related (e.g., insurance quote generation, revising insurance policies, handling insurance claims, underwriting purposes, etc.) and/or financial-related purposes (e.g., obtaining home financing or re-financing). For instance, the method may further include using the home feature information for insurance-related and/or financial-related purposes, such as generating insurance quotes or ultimately handling insurance claims. The method may include additional, less, or alternate actions, including those discussed elsewhere herein.

For instance, the transmitter identifying data may be transmitted in accordance with a personal area networking (PAN) communications protocol, and the information displayed may include one or more of a video of the selling features, a text description of the selling features, one or more images corresponding to the selling features, and/or audio describing the selling features.

In various aspects, a plurality of transmitters may be positioned throughout the dwelling, and the acts of (i) receiving the transmitter identifying data, (ii) sending the transmitter identifying data to an external computing device, (iii) receiving the information to be displayed, and/or (iv) displaying the information as the mobile computing device is within a threshold range of may be repeated for each of the plurality of transmitters such that the selling features associated with each of the different portions of the dwelling are displayed on the mobile computing device as the mobile computing device moves throughout the dwelling.

Furthermore, the mobile computing device may send user identifying data to the external computing device, such as one or more backend components. Upon receiving the user identifying data, aspects include the external computing device correlating the transmitter identifying data to a dwelling address and storing the dwelling address as part of a user profile associated with the user identifying data.

Additionally or alternatively, the external computing device may calculate a homeowners insurance premium quote based upon the dwelling address and information included in the user profile and send the quote to the mobile computing device, which in turn may display the homeowners insurance premium quote for review, approval, and/or modification by the potential or existing customer.

Furthermore, aspects include the external computing device determining whether additional information is required for the external computing device to calculate the homeowners insurance premium quote, and to send an indication to the mobile computing device if the user profile does not include enough data to do so. Upon receiving this indication, the mobile computing device may display one or more prompts requesting the additional information and send the answers to the prompts to the external computing device so the homeowners insurance premium quote may be calculated.

### Exemplary Non-Transitory Computer Readable Medium

In another aspect, a non-transitory computer readable media may be described having instructions stored thereon in a mobile computing device to display information thereon that, when executed by a processor, cause the processor to: (1) receive transmitter identifying data broadcasted from a transmitter positioned at a predetermined location associated with a dwelling when the mobile computing device is within a threshold range of the transmitter; (2) send the transmitter identifying data to an external computing device via a communication network, the external computing device correlating the transmitter identifying data with information to be displayed on the mobile computing device upon receiving the transmitter identifying data; (3) receive the information to be displayed; and/or (4) display the information. The information may include a description of selling features for the dwelling that are associated with the predetermined location such that collection of home feature information via wireless communication or data transmission for insurance-related or financial-related purposes is facilitated. For instance, the instructions may further relate to generating insurance quotes, generating information about financial products (such as home loans or home re-financing), and/or handling insurance claims. The non-transitory computer readable media may include instructions with additional, less, or alternate functionality, including that discussed elsewhere herein.

For instance, the transmitter identifying data may be transmitted in accordance with a personal area networking (PAN) communications protocol, and the information displayed may include one or more of a video of the selling features, a text description of the selling features, one or more images corresponding to the selling features, and/or audio describing the selling features.

In various aspects, a plurality of transmitters may be positioned throughout the dwelling, and the non-transitory media may further include instructions that, when executed by a processor, cause the processor to repeat the acts of (i) receiving the transmitter identifying data, (ii) sending the transmitter identifying data to an external computing device, (iii) receiving the information to be displayed, and/or (iv) displaying the information as the mobile computing device is within a threshold range of may be repeated for each of the plurality of transmitters such that the selling features associated with each of the different portions of the dwelling are displayed on the mobile computing device as the mobile computing device moves throughout the dwelling. In some embodiments, the threshold range may be associated with a distance or physical relationship between the mobile computing device and the transmitter, and/or signal characteristics of data transmission or wireless communications sent between the mobile computing device and the transmitter (such as signal strength, power, quality of signal, interference, reception quality, etc.). Other threshold ranges may be used.

Furthermore, the non-transitory media may further include instructions that, when executed by a processor, cause the processor to send user identifying data to the external computing device, such as one or more backend components. Upon receiving the user identifying data, aspects include the external computing device correlating the transmitter identifying data to a dwelling address and storing the dwelling address as part of a user profile associated with the user identifying data.

Additionally or alternatively, the external computing device may calculate a homeowners insurance premium quote based upon the dwelling address and information included in the user profile and send this to the mobile computing device. The non-transitory media may further include instructions that, when executed by a processor, cause the processor to display the homeowners insurance premium quote.

Furthermore, aspects include the external computing device determining whether additional information is required for the external computing device to calculate the homeowners insurance premium quote, and to send an indication to the mobile computing device if the user profile does not include enough data to do so. Upon receiving this indication, the non-transitory media may further include instructions that, when executed by a processor, cause the processor to display one or more prompts requesting the additional information and send the answers to the prompts to the external computing device so the homeowners insurance premium quote may be calculated.

### Exemplary Mobile Computing Device

In yet another aspect, a mobile computing device may be described including a communication unit configured to: (1) receive transmitter identifying data broadcasted from a transmitter positioned at a predetermined location associated with a dwelling when the mobile computing device is within a threshold range of the transmitter; (2) send the transmitter identifying data to an external computing device via a communication network, the external computing device correlating the transmitter identifying data with information to be displayed on the mobile computing device upon receiving the transmitter identifying data; and/or (3) receive the information to be displayed. The mobile computing device may also include a graphics processing unit (GPU) configured to cause the information to be displayed on the mobile computing device. The information may include a description of selling features for the dwelling that are associated with the predetermined location.

Additionally or alternatively, the transmitter identifying data may be transmitted in accordance with a personal area networking (PAN) communications protocol, and the information displayed may include one or more of a video of the selling features, a text description of the selling features, one or more images corresponding to the selling features, and audio describing the selling features.

In various aspects, a plurality of transmitters may be positioned throughout the dwelling, and the communication unit may be further configured to (i) receive the transmitter identifying data, (ii) send the transmitter identifying data to an external computing device, and/or (iii) receive the information to be displayed for each of the plurality of transmitters. In accordance with such aspects, the GPU may be further configured to cause the information for each of the plurality of transmitters to be displayed as the mobile computing device is within a threshold range of each of the plurality of transmitters, such that the selling features associated with each of the different portions of the dwelling are displayed on the mobile computing device as the mobile computing device moves throughout the dwelling.

Furthermore, the communication unit is further configured to send user identifying data to the external computing device. Upon receiving the user identifying data, aspects include the external computing device correlating the transmitter identifying data to a dwelling address and storing the dwelling address as part of a user profile associated with the user identifying data.

Additionally or alternatively, the external computing device may calculate a homeowners insurance premium quote based upon the dwelling address and information included in the user profile and send this to the mobile computing device. In accordance with such aspects, the GPU may be further configured to cause the homeowners insurance premium quote to be displayed on the mobile computing device.

Furthermore, aspects include the external computing device determining whether additional information is required for the external computing device to calculate the homeowners insurance premium quote, and/or to send an indication to the mobile computing device if the user profile does not include enough data to do so. In accordance with such aspects, the communication unit may be further configured to receive the indication from the external computing device. Upon receiving the indication, the GPU may be further configured to cause one or more prompts to be displayed on the mobile computing device requesting the additional information. The communication unit may be further configured to send the answers to the prompts to the external computing device so the homeowners insurance premium quote may be calculated.

### Additional Considerations

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One may be implement numerous alternate embodiments, using either current technology or technology developed after the filing date of this application.

1. A computer-implemented method comprising:
receiving, by a mobile computing device, transmitter identifying data broadcasted as a signal from a transmitter positioned at a predetermined location associated with a physical environment when the mobile computing device is within a threshold range of the transmitter,
the transmitter identifying data being broadcast by the transmitter in a broadcast-only mode by which the transmitter communicates unidirectionally to the mobile computing device without receiving communications from the mobile computing device, the transmitter identifying data containing one or more parameters including a calibrated signal strength value indicative of a predetermined strength of the broadcasted signal at a predetermined distance from the predetermined location, and wherein the mobile computing device is configured via an application to receive the transmitter identifying data be listening for the transmitter identifying data without sending communications to the transmitter;
measuring, at the mobile computing device, a signal strength of the broadcasted signal as received at the mobile computing device;
determining, at the mobile computing device based at least upon the measured signal strength and the transmitter identifying data including the calibrated signal strength value, a location of the mobile computing device with respect to the predetermined location of the physical environment, wherein determining the location of the mobile computing device comprises determining that the mobile computing device is within a predetermined range of the predetermined location of the physical environment;
responsive to the determining at the mobile computing device that the mobile computing device is within the predetermined range of the predetermined location, sending, by the mobile computing device, the transmitter identifying data to an external computing device via a communication network, the external computing device correlating the transmitter identifying data with information to be displayed on the mobile computing device upon receiving the transmitter identifying data;
receiving, by the mobile computing device, via the external computing device, the information to be displayed; and
displaying, by the mobile computing device, the information.

2. The computer-implemented method of claim 1, wherein the act of receiving the transmitter identifying data comprises:
receiving the transmitter identifying data in accordance with a personal area networking (PAN) communications protocol.

3. The computer-implemented method of claim 1, wherein the physical environment comprises a dwelling, and wherein the information includes information selected from the group consisting of:
a video of selling features of the dwelling;
a text description of the selling features;
one or more images corresponding to the selling features; and
audio describing the selling features.

4. The computer-implemented method of claim 1, wherein the transmitter is from among a plurality of transmitters positioned at different portions of the physical environment, and
repeating the acts of (i) receiving the transmitter identifying data, (ii) sending the transmitter identifying data to an external computing device, (iii) receiving the information to be displayed, and (iv) displaying the information as the mobile computing device is within a threshold range of each of the plurality of transmitters such that the selling features associated with each of the different portions of the physical environment are displayed on the mobile computing device as the mobile computing device moves throughout the physical environment.

5. The computer-implemented method of claim 1, wherein the physical environment comprises a dwelling, and wherein the method further comprises:
sending, by the mobile computing device, user identifying data to the external computing device, and
wherein the external computing device further correlates the transmitter identifying data to a dwelling address and stores the dwelling address as part of a user profile associated with the user identifying data.

6. The computer-implemented method of claim 5, further comprising:
displaying, by the mobile computing device, a homeowners insurance premium quote that is calculated by the external computing device based upon the dwelling address and information included in the user profile.

7. The computer-implemented method of claim 6, further comprising:
receiving, by the mobile computing device from the external computing device, an indication of additional information required for the external computing device to calculate the homeowners insurance premium quote if the user profile does not include enough data to do so;
displaying, by the mobile computing device, a prompt requesting the additional information; and
sending, by the mobile computing device, answers to the prompts to the external computing device.

8. One or more non-transitory computer readable media having instructions stored thereon in a mobile computing device that, when executed by a processor, cause the processor to:
receive transmitter identifying data broadcasted as signal from a transmitter positioned at a predetermined location associated with a physical environment when the mobile computing device is within a threshold range of the transmitter,
the transmitter identifying data being broadcast by the transmitter in a broadcast-only mode by which the transmitter communicates unidirectionally to the mobile computing device without receiving communications from the mobile computing device, the transmitter identifying data containing one or more parameters including a calibrated signal strength value indicative of a predetermined strength of the broadcasted signal at a predetermined distance from the predetermined location, and wherein the mobile computing device is configured via an application to receive the transmitter identifying data be listening for the transmitter identifying data without sending communications to the transmitter;
measure, at the mobile computing device, a signal strength of the broadcasted signal as received at the mobile computing device;
determine, at the mobile computing device based at least upon the measured signal strength and the transmitter identifying data including the calibrated signal strength value, a location of the mobile computing device with respect to the predetermined location of the physical environment, wherein determining the location of the mobile computing device comprises determining that the mobile computing device is within a predetermined range of the predetermined location of the physical environment;
responsive to the determining at the mobile computing device that the mobile computing device is within the predetermined range of the predetermined location, send the transmitter identifying data to an external computing device via a communication network, the external computing device correlating the transmitter identifying data with information to be displayed on the mobile computing device upon receiving the transmitter identifying data;
receive, via the external computing device, the information to be displayed; and
display the information on the mobile computing device.

9. The one or more non-transitory computer readable media of claim 8, wherein the instructions to receive the transmitter identifying data further include instructions that, when executed by the processor, cause the processor to receive the transmitter identifying data in accordance with the PAN communications protocol.

10. The one or more non-transitory computer readable media of claim 8, wherein the physical environment comprises a dwelling, and wherein the information includes information selected from the group consisting of:
a video of selling features of the dwelling;
a text description of the selling features;
one or more images corresponding to the selling features; and
audio describing the selling features.

11. The one or more non-transitory computer readable media of claim 8, wherein the transmitter is from among a plurality of transmitters positioned at different portions of the physical environment, and further including instructions that, when executed by the processor, cause the processor to repeat the execution of the acts of:
(i) receiving the transmitter identifying data, (ii) sending the transmitter identifying data to an external computing device, (iii) receiving the information to be displayed, and (iv) displaying the information as the mobile computing device is within a threshold range of each of the plurality of transmitters such that the selling features associated with each of the different portions of the physical environment are displayed on the mobile computing device as the mobile computing device moves throughout the physical environment.

12. The one or more non-transitory computer readable media of claim 8, wherein the physical environment comprises a dwelling, and wherein the non-transitory computer readable media further includes instructions, when executed by the processor further cause the processor to:
send, by the mobile computing device, user identifying data to the external computing device, and
wherein the external computing device further correlates the transmitter identifying data to a dwelling address and stores the dwelling address as part of a user profile associated with the user identifying data.

13. The one or more non-transitory computer readable media of claim 12, further including instructions that, when executed by the processor, cause the processor to display a homeowners insurance premium quote calculated by the external computing device based upon the dwelling address and information included in the user profile.

14. The one or more non-transitory computer readable media of claim 13, further including instructions that, when executed by the processor, cause the processor to:
receive, from the external computing device, an indication of additional information required for the external computing device to calculate the homeowners insurance premium quote if the user profile does not include enough data to do so;
display a prompt requesting the additional information; and
send answers to the prompts to the external computing device.

15. A mobile computing device, comprising:
a communication unit; a location acquisition unit;
a user interface;
one or more processors; and
one or more computer memories storing non-transitory instructions that, when executed via the one or more processors, cause the mobile computing device to:
via the communication unit, receive transmitter identifying data broadcasted from a transmitter positioned at a predetermined location associated with a physical environment when the mobile computing device is within a threshold range of the transmitter,
the transmitter identifying data being broadcast by the transmitter in a broadcast-only mode by which the transmitter communicates unidirectionally to the mobile computing device without receiving communications from the mobile computing device, the transmitter identifying data containing one or more parameters including a calibrated signal strength value indicative of a predetermined strength of the broadcasted signal at a predetermined distance from the predetermined location, and wherein the mobile computing device is configured via an application to receive the transmitter identifying data be listening for the transmitter identifying data without sending communications to the transmitter;
via the location acquisition unit, measure a signal strength of the broadcasted signal as received at the mobile computing device;
via the location acquisition unit, determine, based at least upon the measured signal strength and the transmitter identifying data including the calibrated signal strength value, a location of the mobile computing device with respect to the predetermined location of the physical environment, wherein determining the location of the mobile computing device comprises determining that the mobile computing device is within a predetermined range of the predetermined location of the physical environment;
via the communication unit, responsive to the determining via the location acquisition unit that the mobile computing device is within the predetermined range of the predetermined location, send the transmitter identifying data to an external computing device via a communication network, the external computing device correlating the transmitter identifying data with information to be displayed on the mobile computing device upon receiving the transmitter identifying data; and
via the communication unit, receive, via the external computing device, the information to be displayed; and
via the user interface, display the information on the mobile computing device.

16. The mobile computing device of claim 15, wherein the communication unit is configured to receive the transmitter identifying data in accordance with a personal area networking (PAN) communications protocol.

17. The mobile computing device of claim 15, wherein the physical environment comprises a dwelling, and wherein the information includes information selected from the group consisting of:
a video of selling features of the dwelling;
a text description of the selling features;
one or more images corresponding to the selling features; and
audio describing the selling features.

18. The mobile computing device of claim 15, wherein the transmitter is from among a plurality of transmitters positioned at different portions of the physical environment, and
wherein the communication unit is further configured to (i) receive the transmitter identifying data, (ii) send the transmitter identifying data to an external computing device, and (iii) receive the information to be displayed for each of the plurality of transmitters, and
wherein the user interface is further configured to display the information for each of the plurality of transmitters as the mobile computing device is within a threshold range of each of the plurality of transmitters, such that the selling features associated with each of the different portions of the physical environment are displayed on the mobile computing device as the mobile computing device moves throughout the physical environment.

19. The mobile computing device of claim 15, wherein the physical environment comprises a dwelling, and wherein the communication unit is further configured to send user identifying data to the external computing device, and
wherein the external computing device further correlates the transmitter identifying data to a dwelling address and stores the dwelling address as part of a user profile associated with the user identifying data.

20. The mobile computing device of claim 19, wherein the user interface is further configured to display a homeowners insurance premium quote on the mobile computing device, and
wherein the homeowners insurance premium quote is calculated by the external computing device based upon the dwelling address and information included in the user profile.

21. The mobile computing device of claim 20, wherein:
the communication unit is further configured to receive, from the external computing device, an indication of additional information required for the external computing device to calculate the homeowners insurance premium quote if the user profile does not include enough data to do so, and
the user interface is further configured to display a prompt on the mobile computing device requesting the additional information; and
the communication unit is further configured to send answers to the prompts to the external computing device.
